(19) United States
(12) Patent Application Publication
(10) Pub. No.: US 2012/0178063 A1
(43) Pub. Date: Jul. 12, 2012

(54) Health/Wellness Appliance

(76) Inventors: Stephen Dixon Bristow, Los Altos, CA (US); Karen Ruth Drexler, Los Altos Hills, CA (US); Robert Chapman Wishnowsky, Pleasanton, CA (US); Robert Dennis Berkowitz, Menlo Park, CA (US)

(21) Appl. No.: 13/179,505

(22) Filed: Jul. 9, 2011

Related U.S. Application Data
(60) Provisional application No. 61/363,360, filed on Jul. 12, 2010.

(51) Int. Cl. G09B 19/00

(52) U.S. Cl. 434/236

(57) ABSTRACT

A simple, low cost device to communicate important information about a change in state relative to someone's health or wellness, ie recovery from surgery or illness. This invention focuses on the delivery of such information in audio (or video) format, tailored to the language needs of the patient or caregiver, in a simple, intuitive device that the user can access any time to hear the appropriate message.

In it's simplest embodiment, the device is a disposable VoiceCard with multiple buttons, each providing an important message for a different stage of a patient's journey (ie just after surgery, early recovery, full recovery). The VoiceCard can also be combined with a greeting card, either as a physical device or digital product, to “gift” valuable medical information in conjunction with well wishes.

### CROSS-REFERENCE TO RELATED APPLICATIONS

This Application claims priority to U.S. Provisional Application No. 61/363360, filed Jul. 12, 2010, entitled “Health/Wellness Appliance”, which is incorporated by reference herein. U.S. application Ser. No. 12/951,059, “Electronic Medical Voice Instruction System”, filed Nov. 21, 2010, is incorporated by reference.

### BACKGROUND OF THE INVENTION

There is significant attention being paid to the areas of patient education, training and compliance. The practice of medicine is compromised by the ability and willingness of patients to follow the instructions of medical professionals or those who lead programs in health and wellness. The purpose of this invention is to provide a simple tool to motivate users to follow instructions from a health care professional or program leader and to provide information and reassurance for the user. An additional purpose of this invention is to increase efficiencies in the health care system by reducing the burden on health care professionals to respond to commonly asked questions and increase patient self-sufficiency overall. This tool can take many forms and can address a wide range of medical/health/wellness situations.

When a patient is diagnosed with a condition (e.g. diabetes), s/he is prescribed a new medication (e.g. warfarin or insulin), started on a new device (e.g. insulin pump or nebulizer), undergoes a procedure (such as a surgical or diagnostic procedure) or starts a new program (e.g. for weight loss or exercise), s/he goes through several stages of learning and accepting, a sort of a journey. Initially, there is stress and often pain (e.g. following a surgical procedure). Patients need to be reassured that what they are experiencing is normal and need to know what to do to take care of them selves. As stress and pain lessen, focus shifts to resuming personal function such as eating and basic mobility. As such function returns, the focus further shifts to broader social activities—returning to work, exercising, etc. The Journey is shown in FIG. 1.

This staged approach is used in some of the preferred embodiments for this invention. In this example, described in the prior application, a physical or virtual card is created with individual audio messages that are somewhat sequential in nature. There is an additional message to provide information about what to look for if something goes wrong. Market research was conducted with patients who used prototype Medivoce VoiceCards following laparoscopic hernia and gall bladder procedures, or when newly prescribed warfarin. Both patients and healthcare providers demonstrated a high level of satisfaction with the VoiceCards. Patients appreciated the easy access to information at the touch of a button. They liked being able to repeatedly play certain messages without feeling embarrassed that they needed to call the doctor's office for yet another question. Health care professionals appreciated a reduced need to respond to patient calls focused on commonly asked questions. See FIG. 2 for a sample of the graphics used in the VoiceCard for assisting patients recovering from hernia surgery.

Increased patient satisfaction is important for several reasons. Satisfaction is an important component of adherence, and it is well understood that lack of adherence is a significant cost to our health care system.^{1,2,3,4} Patients who do not take their medications as prescribed are more likely to have need of further medical attention. Many physicians use word of mouth to grow their practices and patient satisfaction is important to the business of the practice of medicine. Some clinics and hospitals are now incorporating patient satisfaction scores in reviews of physicians to motivate doctors to pay more attention to patient satisfaction.

The VoiceCard need not follow the Journey concept. In an alternate embodiment, it may be advantageous to highlight multiple aspects. For example, for a patient undergoing orthopedic surgery, it may be important to work in parallel on inflammation, mobility and strength. Each section of the card may provide information about why each aspect is critical for a full recovery while also providing useful tips for improvement.

There are many situations in which a simple motivational and educational tool can be of great value. Certain applications were previously described such as before and after medical procedures and upon starting new medications. But there are many potential additional applications. Within the medical arena, patients (or family members or other care givers) would benefit from spoken, reassuring, motivating instructions to familiarize themselves with new medical devices such as insulin pumps, nebulizers and glucose monitoring devices. Often, after days or weeks of use, the procedures become routine, but initially fear and anxiety are frequently prevalent. There are discharge instructions printed for everyone leaving a hospital or surgicenter—and a VoiceCard recording that focuses in on the most important elements of follow-on care would be quite useful. People dealing with constant pain might also be comforted and reassured if they could easily be reminded of measures they can take to alleviate pain—or just to feel as if they can take some control. A key aspect of the series of instructions in the VoiceCard is to motivate the user to take more and more control over his/her own care/situation. In situations where the pain will subside over time (such as following joint replacement or other surgery) the VoiceCard could help set expectations for healing and recovery. There could be reminders for how to deal with pain and motivating elements to help patients move from iv morphine to oral morphine to drugs with which the patient could be sent home from the hospital. Encouraging comments about the role of physical therapy in reducing pain and the need for pain meds could also be included.

Caregivers need special instruction to ensure their own health while caring for family members who have become infirm or frail. Helping stroke patients, those dealing with joint issues, or patients undergoing rehabilitation to move safely in such a way as to not injure ones self is critically important but not frequently taught. VoiceCards that instruct on proper lifting of frail family members without hurting either party would save the cost and burden of the many injuries that result from improper techniques. Instructions for rehabilitation exercises, to match print outs or instructions provided by physical therapists, could increase patient confidence and comfort in exercising in between physical therapy visits. There are important motivational aspects to assure early success with programs such as weight loss or exercise initiation, and early success is key to continuance.

### REFERENCES

¹ Osterberg L, Blaschke T. Adherence to medication. New Engl J Med 2005; 353:487-497.

² Jencks S F, Williams M V, Coleman E A. Rehospitalizations among patients in the Medicare Fee-for-Service Program. New Engl J Med 2009; 360:1418-1428.

³ Zolnierek K B H, DiMatteo M R. Physician communication and patient adherence to treatment: a meta-analysis. Med Care 2009; 47:826-834.

⁴ Roter D L, Hall J A. Communication and adherence: moving from prediction to Understanding. Med Care 2009; 47:823-825.

### SUMMARY OF THE INVENTION

The HWA (health/wellness appliance), in its simplest embodiment, can be an inexpensive, disposable VoiceCard or digital version thereof. The VoiceCard provides users with visual and audible information that helps them to adapt to a new disease state or condition, learn to live with a complex medication regime, recover from surgery or injury or participate in wellness programs.

HWA may be configured to provide several different series of messages and graphics based on either user action or user status. The HWA, in this embodiment, is updateable and dynamic.

The HWA can be a device that will support a user or users over a long period of time, through various conditions and programs relating to their health and wellbeing. Such as device can be an invaluable aid to proactively managing health while helping to reduce the burden of support on the medical community.

The functionality of providing information and motivation relating to a medical scenario can be combined in a greeting card. In addition to the typical well wishes, including an area for a personal message, the card could include the multi-button VoiceCard to add utility for the patient and increase the value of the sentimental gesture. This functionality can be delivered electronically as well, combining both a personal, get-well message and information to assist with healing and recovery.

### BRIEF DESCRIPTION OF DRAWINGS

FIG. 1—Illustration of the Journey patients follow when diagnosed with a new condition or when recovering from a procedure. The messages provided via VoiceCard or other HWA can be tailored to reflect what is of most concern to the user at different stages of this journey.

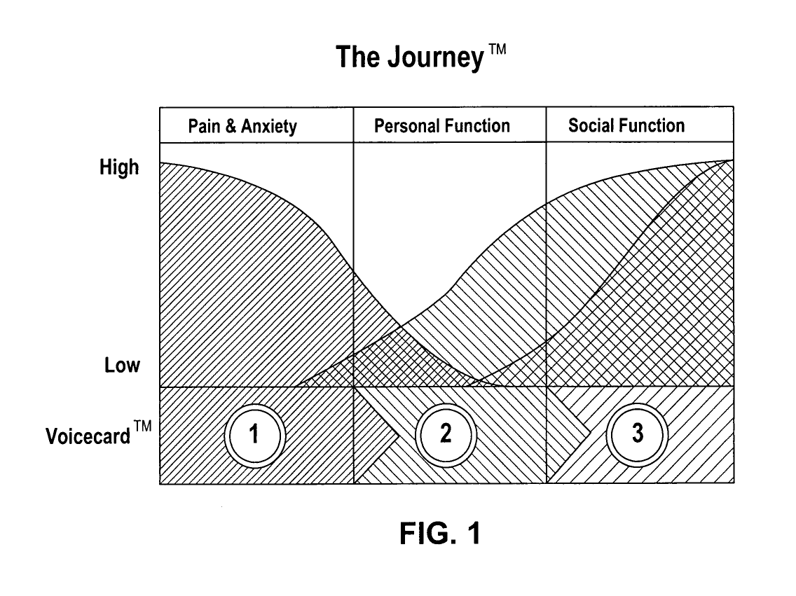

FIG. 2—Sample graphics for a VoiceCard designed to assist patients recovering from arthroscopic hernia surgery.

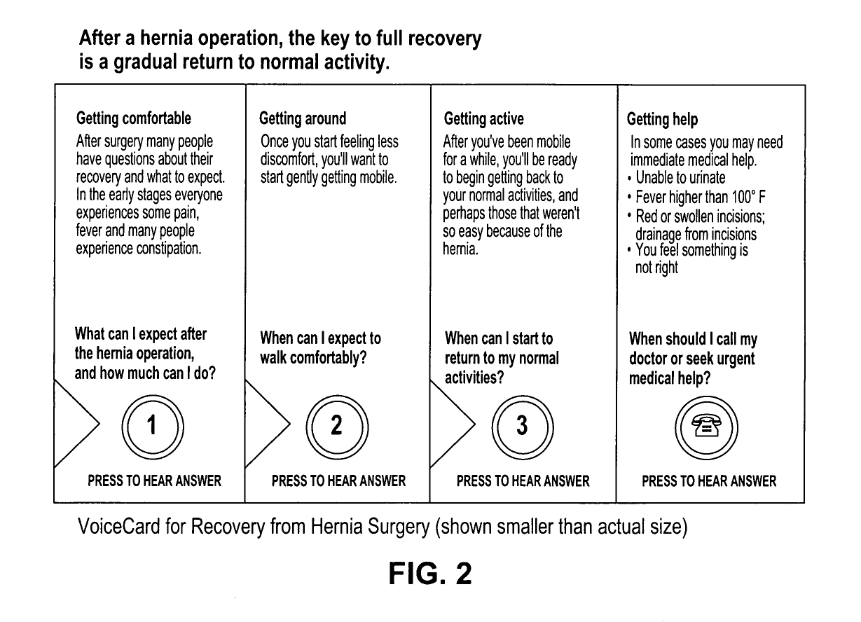

FIG. 3—Schematic of a contactless charging system for a HWA, in which the appliance would simply be placed onto the contact surface.

FIG. 4—Simulated illustrations of linear and block bar codes. The relative size of the blocks shown is larger than actual so as to make the illustration more readable. Practically, the spacing and size of the dots in the blocks matrix are much smaller than in the illustration. These are examples of optical means for loading information into the HWA.

FIG. 5—VoiceCard combined with a greeting card. This can be a physical card or a digital version with buttons to press to play the various messages relating to the patient's condition.

### DETAILED DESCRIPTION OF THE INVENTION

The HWA (health/wellness appliance), in its simplest embodiment, can be an inexpensive, disposable VoiceCard or digital version thereof.

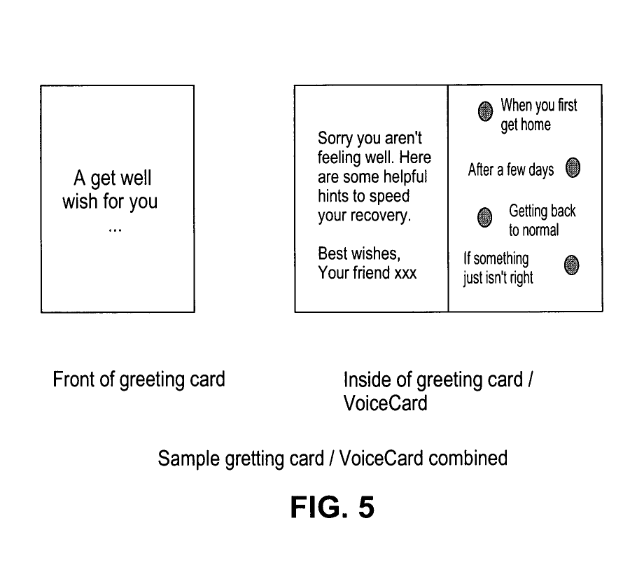

The functionality of providing information and motivation relating to a medical scenario can be combined in a greeting card. For example, an individual might purchase a get-well card for someone undergoing surgery. In addition to the typical well wishes, including an area for a personal message, the card could include the multi-button VoiceCard to add utility for the patient and increase the value of the sentimental gesture. This functionality can be delivered electronically as well, combining both a personal, get-well message and information to assist with healing and recovery. See FIG. 5.

HWA may be configured to provide several different series of messages based on either user action or user status. The HWA, in this embodiment, is updateable and dynamic. For example, the appliance may be updated based on changes in the patient's status. A second or third or later set of messages may be triggered by one of several options: (1) the patient can push a specific series of buttons to tell the card to load the next set of messages, e.g. more advanced exercises for a patient who has passed certain recovery milestones, some of which may be assessed b the card (ie grip strength) (2) the health care provider can send a message (wired or wireless) to communicate that the patient is ready for the next set of messages, or (3) the card may include a means for sensing the user and configuring the messages specifically for the user who is in proximity via fingerprint, voice or face recognition or communication from an RFID signal.

In a further embodiment, the graphics and audio/video portions of the HWA can be updated with the mechanisms described above. In these cases, there is an active means for displaying graphics, either a screen or electronic paper that can change configuration based on user or external inputs. In this way, the graphics in addition to the audio/video message can be tailored to the user and the status of the user for enhanced personalization, one of the important features of motivation. In a simpler version, there can be layers of graphics that peel off, revealing the next set of instructions when the buttons are updated by one of variety of methods. Low tack adhesive, such as the type used in Post-It® Notes, might be useful for removal graphic layers of this type.

In another embodiment, the HWA can sense when a layer of graphics is removed, which can trigger the automatic loading of the next set of audio instructions. There can be a simple reflective photo sensor and underlying electronics to detect the removal of a layer or a membrane or tear strip that is ruptured when the top layer of graphics is removed, triggering an update to the messages for each button. While tear strips have been used for purposes such as activating the battery circuit in electronic devices, the use of such an approach to signal a change in state in a device is unique.

If a user does not have his/her HWA with him/her, the most updated message can be provided telephonically. The user can dial a phone number and input an authentication code to access the personal information that has been stored on the HWA. On the surface, this invention may appear to have similarities to ordinary enquiries that use a dial in number with some user identification and password to unlock information such as an individual's bank balance.

What differentiates this invention is that:
A—It is part of an integrated medical information system. The system includes a portable HWA such as the VoiceCard with a seamless means for updating the audio (or video) messages on the HWA, provisions for updating the graphics on the card, and a back up system wherein a user who does not have his/her card can access important information about use of a drug, recovery from a procedure, or use of a medical device, for example.
B—the information is a duplicate of what is simultaneously being provided to the user's HWA.

This user authentication may involve entering an account number and PIN after dialing in or combining the phone number of the user, as received at a processing site, along with a recognized voice password or response to a question to allow the user to access his/her information without the need to press keys or remember long voicemail-like trees of information.

In another version, the information on the buttons can be provided via voice mail message(s), triggered either by user action or by the physician. The messages can remain available for the user to listen to as needed. In an alternate embodiment, the text could be provided via email or text message, although this option eliminates the use of voice that is a key benefit of this invention. Alternately, an email or emails can be sent that include the mp3 files for the audio messages.

For versions of this invention that can be updated, there is a need to recharge the batteries. By a simple means of providing energy for a long time, the HWA can have a life measured in years, not weeks. It is sensible to keep the onboard battery capacity small to keep the device streamlined and portable.

The need to power and operate portable appliances is a long-standing issue. There are limitations to how long the battery will last in normal use. If the battery is a primary cell (not rechargeable), the device has a fixed lifetime; once the battery is discharged the product will cease to function. If the product uses a secondary cell (can be recharged), how the battery is actually recharged affects the product design. Electrical contacts are sensitive to the mechanical design of the charging contacts and to corrosion and oxide build-up due to the environment.

Magnetic coupling has been used in products such as electric toothbrushes to couple energy for recharging batteries from a base unit charger to a portable electric toothbrush. Typically these charging systems are comprised of a sleeve or prong that the primary of a line frequency power transformer couples to a secondary winding of the transformer that is in the portable device. Their charging is inefficient due to the gaps in between the primary and secondary windings. The charging system requires a mating physical contact that limits the location of the portable appliance to a specific orientation relative to the charging base.

Newer technology high frequency devices have been introduced in the market as of 2009 which create a high frequency RF field on a charging mat that allows a portable appliance such as a cell phone or music player to be charged. These systems require the charged appliance has a special charging coupling device built into it or that the charged appliance has a charge-coupling device attached to it. In use the appliance to be charged is simply placed in a random orientation onto the mat and is charged by the coupling of the high frequency RF field to it.

This invention contemplates the first ever use of a non-contact charging system for a portable HWA. The solution of providing a charging contact or connector is the obvious one. The Medivoce HWA is intended to be used by untrained users who may not have the dexterity to place the HWA precisely into a charging cradle, thus the non-contact system is cleared preferred.

Prior art contactless systems have required precise alignment of the charged appliance and the charging device partially due to the need to minimize the size of the charging interface. Recent charge mat technology has required the use of high frequency RF energy so that the small size of the charged device is not a detriment to capturing enough radiated energy.

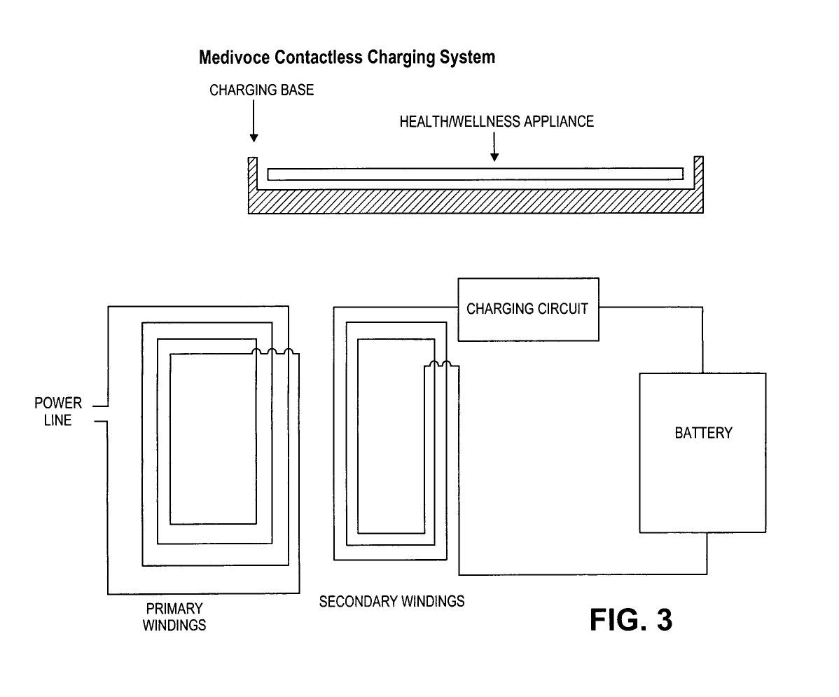

Medivoce's charging system is unique in its use of the inherent large form factor of the HWA to allow inexpensive printed circuit traces to capture sufficient energy to charge its battery, without the need for precise alignment or the need for flux concentrating discrete components. The large size of the anticipated HWA allows (but does not require) the use of lower frequencies, down to line frequencies, to be used. If lower frequencies are used, the elimination of the need to change the power line frequency to a higher frequency eliminates the extra cost of any frequency conversion circuitry. The use of lower frequencies with the inherent longer electrical wavelength makes the Medivoce HWA less sensitive to distance issues based upon wavelength. The use of a non-contact based charging system also provides an advantage for the Medivoce appliance as it allows it to be sealed and water resistant. See FIG. 3.

In another embodiment, the performance of the user is measured and the measurement is used to provide an evaluation of user progress and/or to allow the user to have a different experience once the user has achieved a goal. For example, the speed at which the user can press the buttons in a sequence, the speed at which the user can react to a command and press a button, the ability of the user to manipulate the card by moving it in a translational or rotational manner and the force that the user can apply in pressing the buttons can all be measured and used to determine the messages or information that will be displayed and available.

Current video game products such as the Nintendo WII® and the Microsoft Xbox® make use of force sensitive push button assemblies. Depending on the force applied by the user to the button a variable analog or digital signal is produced. Nintendo and Radica have produced and shown game controllers that make use of MEMS [Micro Electronics Mechanical Systems] accelerometers to produce varying outputs depending on the orientation of the controller. Cell phones such as the Apple iPhone® and the Samsung Momentum® have accelerometers that sense the orientation of the product as it is held by the user. Due to the mass production of MEMS accelerometers, the price is currently less than $1.50 and will soon be below $0.50. The cost of force sensing resistors has also declined as the vendors who produce these products have cut the prices to well under $0.25 per button.

No one has applied this technology to the field of portable health/wellness appliances such as the VoiceCard. Taking this proven technology and using it in a new way and new field establishes this embodiment of this invention. This enhanced input has many applications. The following listing is not all-inclusive but serves to illustrate some of the things that this new embodiment allows.
a—Measuring the force with which a user can press a button without pain can give an indication of how recovery from surgery is progressing. Based upon measured results the user may be instructed to move to the next phase or may be given information pertinent to the user's current state. This user could be told to move on and press the button for the next phase of the “journey” or the measured results could be used to cause the HWA to obtain a new set of graphic and/or audio data appropriate to the measured value.
b—Prompting the user to press a button “as fast as you can” so that the dexterity of the user can be measured. In some conditions, such as Parkinson's disease, the ability to perform a repeated function is a measure that may be used to gauge the state of the user and the effectiveness of the current medication regime. Depending on the result, a message to contact one's doctor about possible adjustments to meds being taken could be generated, as one example, or the HWA could automatically load messages that are consistent with the performance ability of the user.
c—Prompting the user to move the portable HWA in a variety of motions and rotations. This information may be used to gauge the degree of movement that the user has reached after some procedure, or could be used to give an indication of the current state of the user suffering from a chronic or degenerative disease. The ability of low cost sensors to measure both the motion of the HWA and the acceleration that it experiences will enable assessment of both the degree of movement as well as the speed or ability of the user to accelerate the mass of the appliance. This information may be used to gauge the state of the user and the effectiveness of the medication regime. The results, or whether there has been an improvement or decline in performance, could lead to the display or download of a message that is geared to the results obtained.
d—Allowing a health care professional to set up a series of gates for the user in order for the user to progress to a next stage of physical therapy or healing. The health care professional can input or select criteria to be met by the user, the HWA can then prompt and measure the ability of the user to perform the functions. For example, the gate for the user to be allowed to “use a computer” might be set to be the ability to press buttons 1 through 4 in succession in 4 seconds while moving the appliance up and down 4 times, all within 10 seconds. The example given is fanciful but more meaningful challenges could be established to signal the readiness of the user to move on to the next phase of therapy or resumption of normal activities.

Another embodiment of this invention that a single HWA may be shared among a number of users. If the HWA can be shared within a family or other grouping, a higher price can be justified, and more features and broader performance can be included in the HWA at a marketable and economic price.

The technological building blocks from other fields can be used in an inventive manner to deliver this performance. In this embodiment the RFID technology from the bridge & highway toll field, the fingerprint sensing technology from the computer and access security field, the use of password technology from the banking industry, and the voice recognition technology from the toy industry are examples of technology that can allow a simple HWA to be shared in a secure manner among group members.

Specific, but not limiting, examples of how these technologies might be used follow:
a—RFID—if each user in a group has an RFID device in that user's possession the HWA can be programmed to present information and respond in an appropriate manner to each particular user in the group.
b—Fingerprint—by measuring of the characteristics of a user's fingerprint the HWA can then present information and respond appropriately to each individual in a group. This measurement can be taken by a specific touch that the user is prompted to make upon the HWA, or could be taken just from the natural touches that the user makes when picking up and using the HWA.
c—Password—While the HWA might have a full numeric keyboard, a goal of this invention is to simplify user identification. One alternate means of entering a code is by pressing the provided buttons in a specific pre-set sequence. How the password is entered is not critical. For example, the user may have been prompted earlier to enter a password via a computer interface over the web or have been instructed by the HWA to enter his sequence of buttons directly on the card. What is key to this idea is that the same HWA can be shared by a number of users in a group or household by means of a system that allows each user to be identified by a password.
d—Voice Recognition—rather than require the user to press keys, the system could just prompt the user to answer a question or questions such as “what is your first name”, or “in what year were you born”. A specific example of the use of the system is illustrated in the following dialogue. The user can identify him- or her-self in response to a voice or visual prompt.
   For example:
   HWA upon sensing user: “Welcome, please say your first name”
   User: “FRED”
   HWA: “Thanks FRED, I am now ready with the information that was selected for you. Please select a button.”

In the Internet field a number of companies provide a service to the consumer while the making their money by selling ads that the consumer sees when going to their websites. An example of such a service is the Google search service. All that they provide is free to the user. The user must endure advertising pitches while accessing Google content. This embodiment contemplates combining a HWA with advertising in a number of ways:
a—Providing fixed printed advertising on an HWA that has neither a full screen display nor the ability to be updated. This model is akin to that of selling billboard space at a venue such as a stadium. An HWA that is focused on the transition from oral meds to insulin for a person with diabetes might be “sponsored” by an insulin pump company, for example.
b—Providing both fixed printed advertising on an HWA that does not have a full screen display and/or a customized audio input that incorporates an advertising message during the presentation made to the user. This might be as innocuous as the “this program has been brought to you by company X” that is used in many PBS television programs.
c—Providing the service as in “b” above with the added feature that the advertising could be updated remotely by the advertiser/sponsor via a wired or wireless link.
d—Providing advertising on a HWA that has an electronic paper or other electronic graphic display so that the user sees messages that are programmed before the HWA is sold to the customer or downloaded after the sale by wired or wireless means. This embodiment contemplates that the advertising that the user sees is customized and updateable. It can be customized to reflect the users current status. It can be customized in a timely manner to allow the supplier of the advertising to update the advertising based upon the suppliers' marketing and sales needs.

The advantage to the consumer is that this business model allows for the support of the distribution of HWAs to users with a subsidy that the advertisers are willing to pay because their message is being delivered in a very focused manner to a select group of users. This would be an extremely efficient means to get a messages to patients and should be attractive to businesses that advertise directly to patients/users.

The simple form factor, its ability to have graphics, portability, audio capability, a simple user interface independent of the need for a computer and a limited number of buttons enable the HWA to provide simple and interesting testing regimes for the user. For example, users such as those with memory loss can be provided with comforting words, a message and then a memory challenge test. The message can be a generic one, or if the HWA has the ability to be programmed by the health care professional in the office or in a connected or wireless fashion, the message can be personalized to the condition of the user.

In this embodiment the user could be presented with a memory challenge. It could take a number of forms:
a—Select among a number of answers that are appropriate to the question asked. This is akin to the standard multiple-choice test. This particular test focuses primarily on user recall of information.
b—Repeat a pattern. This pattern could be delivered as an audio instruction such as “press the buttons in order left to right” or it could be a random instruction such as “repeat this pattern”. The pattern could be delivered as audio instructions or in models with a graphic display capability, could allow for the actual desired button presses to be dynamically flashed or indicated while the pattern plays. This is akin to using the Atari ‘Touch Me®’ or Milton Bradley ‘Simon®’ pattern games and which can be used to gauge and challenge a user with memory loss.

Ideally, the content presented would change over time to remain interesting. Such functionality could be used to stimulate patients with memory loss. Means for tracking results or communicating results or trends in performance could be added and the content could be responsive to the performance on prior interactions.

In this embodiment of the HWA there are provisions made so that people other than the manufacturer and seller of the HWA, such as the Medivoce Corporation, can input graphics, programs or audio information into the HWA.

Systems have been set up for the delivery of music files to consumers by companies such as Microsoft with their Zune® product, for the delivery of applications to smart phones. In much the same way, multiple applications including voice, programs or graphics could be delivered to HWAs. What is contemplated is to bring this closed or open garden approach to providing user content to the HWA.

The preferred embodiment is a closed garden approach where Medivoce, another company, or a standards body must approve the content that the user or the health care provider can download to the HWA.

Many of the users of an HWA may be vision or hearing impaired. The provision for support for vision or hearing impaired users is a novel and inventive aspect of this invention. As highlighted in the prior provisional application, the HWA is particularly well suited to users with literacy issues as the majority of the information is provided orally.

It is an intention of this invention to provide appropriate messages to the user. In this embodiment of the invention particular means to improve the interface for blind or hearing-impaired individuals are contemplated. For example, for blind users it is contemplated that the HWA could be constructed so that the keys and printed text on the HWA incorporate Braille bump identification.

The audio output of the HWA being played by the integral speaker may not be optimal for those who would prefer to use an electromagnetically linked hearing aid. For those who need a hearing assistance device an embodiment of the invention could incorporate a speaker or separate transducer aimed at allowing the use of a magnetic coupling that would transduce the magnetic field into an electrical signal that might be amplified by the common hearing aid being used by the wearer. By proper speaker selection this compatibility with hearing aid pick up can be provided at a low cost. Alternatively, a separate coil can be incorporated in the HWA to optimize the ability to work with an electromagnetically coupled hearing aid pickup device.

In another embodiment of this invention a Bluetooth® transceiver is added to the product assembly. The addition of Bluetooth transceiver allows the HWA to send its audio messages directly to a Bluetooth headset and or Bluetooth linked hearing aid that the user may be wearing. The integration of a Bluetooth link into an HWA is novel and not obvious. This embodiment of the invention allows a person who is wearing a Bluetooth enabled headset to hear information from his/her HWA without the need for any wires or speakers built into the HWA. Prior art links using Bluetooth have been focused on the provision of two way telephony or one way music links. The use of this technology with a HWA is novel and provides a clean way for a user to listen to an HWA in privacy, even in a public place.

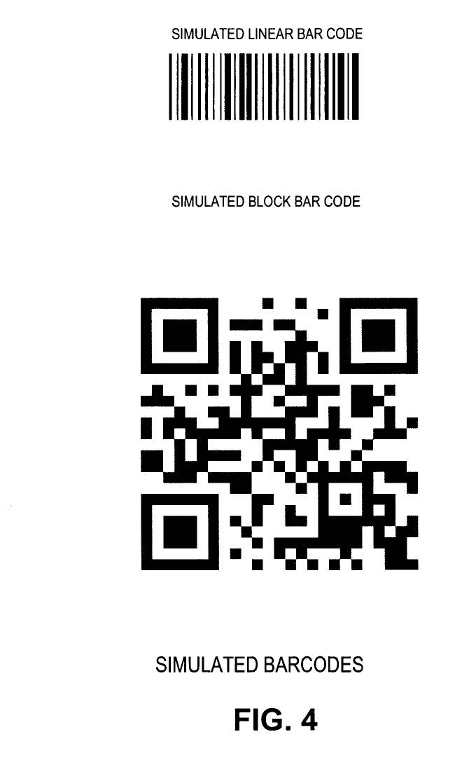

In addition to the previously disclosed embodiments, this invention contemplates the input of programming and data to the HWA via optical means. An advantage of an optical link is that it allows the HWA to be manufactured in a sealed watertight casing without the need for openings for wires or connectors. Especially in the case of an HWA which is shared in a group or family setting or is used with users who might have wet hands or be likely to spill liquids on the HWA, a sealed HWA provides a practical and desirable ability to protect the internal parts of the HWA from damage.
a—An optical one way or two way link that would allow a programming and data transfer device to transfer data to and/or read data from the HWA by an optical link. Such links have typically been IR based in other fields of use such as TV remote controls, IRDA computer peripheral links and hand held organizer links such as manufactured by Palm, Inc. While other light frequencies are contemplated, the current sweet spot for low cost components is in the IR wavelength.
b—An optical input device can be constructed and included at low cost to read bar codes. Bar code readers are low in cost to implement if the user does the scanning and the system only needs to provide an illumination device, a reading photo sensor, and software. Optical input devices of this type have been used in toys for years by companies such as Fisher Price and Leapfrog. The contemplated HWA is small enough and light enough to both allow the user to scan a surface to be read past the bar code reading area of the HWA and to allow the HWA to be physically moved in a scanning motion so that it is the moving element when a bar code is read.
c—A camera style optical input device could be incorporated so that non-linear bar codes could be read. These are the sorts of barcodes that can store a much larger amount of information in the form of a series of blocks in a matrix format. The standard bar code as might be used to encoding pricing on a packaged good in the form of a UPC (Universal Price Code) can only encode a limited field of about 20 digits or so. The block bar codes can encode orders of magnitude more information than a standard linear bar code. By using such a block bar code the time to download files into the HWA can be greatly reduced when compared to the time that it would take to read in the same files using linear bar codes. While a camera input is more expensive than a simple photo sensor that might be used to read linear bar codes, the software needed to interpret a camera input and the cost of the camera IC's themselves have been dropping rapidly as both get used in the current crop of cell phones. For example, one can download applications for smart phones that allow the user to take a picture of a block bar code and have the phone then deliver the decoded information to the user. See FIG. 4.

The VoiceCard and other HWAs can easily be configured to provide the content in the primary language of the user—graphics, audio, etc. Based on market research done, it is clear that there is an advantage to providing a dual language version, which can easily be accomplished through these devices. There can be two languages presented on the two sides of the VoiceCard, for example.

Research has shown that many minority populations in the US do not trust that the information they receive in translation, especially in Spanish, is the same as that provided in English. With a dual-language HWA it will be easy to confirm that the same content is provided in both languages, increasing the level of trust with the health care professionals and providers of the HWAs. In addition, there is often a range of language abilities within a family. The parents might speak mainly one language and the children may speak both the native language and English or perhaps mostly English. Providing a dual language device enables all generations to hear the same information in the language of preference, increasing the utility of the HWA for the users.

There may be circumstances in which it is advantageous to repurpose the VoiceCard or other form of HWA. If there are more buttons on the device than are needed at the moment, it may be useful to include a “dummy” message in case the user pushes the extra button. The message could be something like “Your VoiceCard is working properly. Please listen to the other messages for information provided by your healthcare professional” or “This VoiceCard has been provided by your doctor to help you with your recovery. Proceed to button 2.”

### OBJECTS OF THE INVENTION

The object of this invention is communicate and motivate in order to improve adherence with medical/health and wellness-related instructions and increase patient satisfaction. Lack of adherence is closely correlated with poor outcomes, from not completing full courses of antibiotics and having recurrent infections to not following post-surgical instructions resulting in seriously delayed recovery times. A further object of this invention is to reduce poor outcomes and thus decrease the cost of delivering health care.
Multiple variables affecting physicians and patients contribute to non-adherence . . . Analysis of various patient populations shows that choice of drug, use of concomitant medications, tolerability of drug, and duration of drug treatment influence and prevalence of non-adherence. . . . On average, one third to one half of patients do not comply with prescribed treatment regimens (cardiovascular/hypertension medication). . . . Medication non-adherence results in a significant burden to healthcare utilization—the estimated yearly cost is $396 to $792 million. Additionally, between one third and two thirds of all medication-related hospital admissions are attributed to non-adherence . . . . (Medication nonadherence: an unrecognized cardiovascular risk factor. Munger M A, Van Tassell B W, LaFleur J. (University of Utah, Salt lake City, Utah). MedGenMed. 2007 Sep. 19; 9(3):58.)

Another object of the invention is to provide a tool for Health Care Providers to augment the instructions they currently provide to people. This will reduce the number of inquiries made by patients who are not sure what they should do after they leave the medical office which will reduce the burden on already understaffed practices while improving the quality of care.

Another object of the invention is to provide and enhanced greeting card in which friends and family can provide useful medical information to a patient in conjunction with wishes for recovery and health.

Another object of the invention is to provide users, singly or in groups, with an appliance that can accept various forms of inputs to update and personalize health or wellness information. Such an appliance can become an important ally in the continuum of care through different conditions, disease states and phases of life.

This invention is intended to encourage, educate and, perhaps, amuse the patient while improving both the quality of care and the cost of delivering care.

What we claim:

1. A system that provides sequential information, including audio content, that assists in moving a user through the process of healing or learning about a health or wellness condition or provides medical advice.

2. A system of claim 1 that assists the user with one of the following: learning a new medication regime, recovering from surgery or injury, learning how to use a medical device, learning how to provide care, motivation for behavior change (ie weight loss or smoking cessation).

3. A system of claim 1 wherein the embodiment if a dedicated physical device.

4. A system of claim 1 that is comprised of a digital file or series of files.

5. A greeting card combined with a system that provides sequential information, including audio content, that assists in moving a user through the process of healing or learning about a health or wellness condition, either physical or digital.

6. A system of claim 5 that includes an option for recording a personalized message.

7. A system of claim 3 that uses noncontact methods to transfer power to its internal rechargeable battery.

8. A system of claim 7 wherein the charging power is transferred by one of the following methods: magnetic induction, transmission of light energy, focused light beam, capacitive coupling, or by harvesting the movement of the device and using same to charge the battery.

9. A system of claim 1 that supports multiple users with the ability to identify the user in order to provide individually appropriate information.

10. A system of claim 9 whereby the means to identify the user is one of the following: voice identification, a user entered password or other key (such as series of button presses), physical parameter (such as but not limited to a fingerprint, retinal scan or user image), a unique pattern in a body fluid such as breath, a unique pattern in metrics such as pulse or cardiac rhythms.

11. A system of claim 1 wherein the graphics guide the user to select which message/information segment to play.

12. A system of claim 1 wherein the graphics can be changed or refreshed.

13. A system of claim 3 wherein the graphics can be changed by means of peeling off and removing one graphic layer thereby exposing a new graphics later.

14. A system of claim 13 wherein the peeling back of the graphic layer is sensed and used to trigger a change in the messages available to the user, such that the messages will match the newly exposed graphic layer.

15. A system of claim 1 that senses a parameter of user response or performance and responds based on that input.

16. A system of claim 15 wherein the parameter sensed is at least one of the following: pressing of a button or buttons, possibly incorporating a sequence with specific timing, voice response to a question, assessment of the grip strength or pressure exerted, the manipulation of a device in one or more axes, each directly on a dedicated HWA or on an ancillary device such as a smart phone or computer.

17. A system of claim 1 that downloads and displays information, whereby such information is sent via one of the following methods: scanned in with a bar code, transmitted remotely by a device such as a telephone or computer, sent via optical link, sent via RF link or transmitted by a physical media such as a memory card.

18. A system of claim 15 that updates information based on user responses via one of the following methods: scanned in with a bar code, transmitted remotely by a device such as a telephone or computer, sent via optical link, sent via RF link or transmitted by a physical media such as a memory card.

19. A system of claim 1 that provides feedback to vision or hearing-impaired users.

20. A system of claim 19 that provides feedback to a hearing impaired user in one of the following ways: vibratory feedback to the user's fingers when keys are pressed, piezo electronic induced vibration of the keys, vibration of the device, audio feedback by means of magnetic induction compatible with hearing aids, audio feedback provided by a Bluetooth or DECT link, audio feedback provided by means of an RF signal.

21. A system of claim 19 that provides feedback for vision impaired users by one of the following means: including Braille characters on the keys or providing audio confirmation of all user choices and key selections.

22. A system of claim 1 that provides the same content in two or more languages.

23. A system of claim 1 that automatically loads the content in a language or dialect closely matched to that of the use based on manual entry of a language choice or an assessment done based on user voice input.
